(19) United States
(12) Patent Application Publication
(10) Pub. No.: US 2018/0288647 A1
(43) Pub. Date: Oct. 4, 2018

(54) WIRELESS COMMUNICATION SYSTEM AND METHOD

(71) Applicants: NANNING FUGUI PRECISION INDUSTRIAL CO., LTD., Nanning (CN); HON HAI PRECISION INDUSTRY CO., LTD., New Taipei (TW)

(72) Inventor: CHO-HAN LIN, New Taipei (TW)

(21) Appl. No.: 15/472,294

(22) Filed: Mar. 29, 2017

(51) Int. Cl. H04W 28/02; H04W 72/04; H04W 72/10

(52) U.S. Cl. CPC H04W 28/0268; H04W 28/0257; H04W 72/10; H04W 72/048

(57) ABSTRACT

A wireless communication system includes a baseband processing unit, a remote radio head, and a network connection device. The baseband processing unit obtains downstream packets from an evolved packet core (EPC). The remote radio head transmits long term evolution (LTE) data to the mobile device. The network connection device transmits Wi-Fi data to the mobile device. The baseband processing unit adjusts the ratio between the LTE data and the Wi-Fi data transmitted to the mobile device according to the data throughput of the mobile device. The method which is also disclosed and the system increases network speed.

### FIELD

The subject matter herein generally relates to wireless communication systems and methods.

### BACKGROUND

At present, Wireless-Fidelity (Wi-Fi) and Long Term Evolution (LTE) technology has become the two most successful wireless technologies. In the structure of the micro base station downlink bandwidth is limited to 100˜150 Mbps, this does not meet the user's bandwidth requirements.

### BRIEF DESCRIPTION OF THE DRAWINGS

Implementations of the present disclosure will now be described, by way of example only, with reference to the attached figures.

FIG. 1 is a schematic diagram of an exemplary embodiment of a wireless communication system with a baseband processing unit.

FIG. 2 is a schematic diagram of an exemplary embodiment of the baseband processing unit of FIG. 1.

FIG. 3 is a flowchart of an exemplary embodiment of a wireless communication method.

FIGS. 4A and 4B are flowcharts of an exemplary embodiment of a load ratio calculation process in the method of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

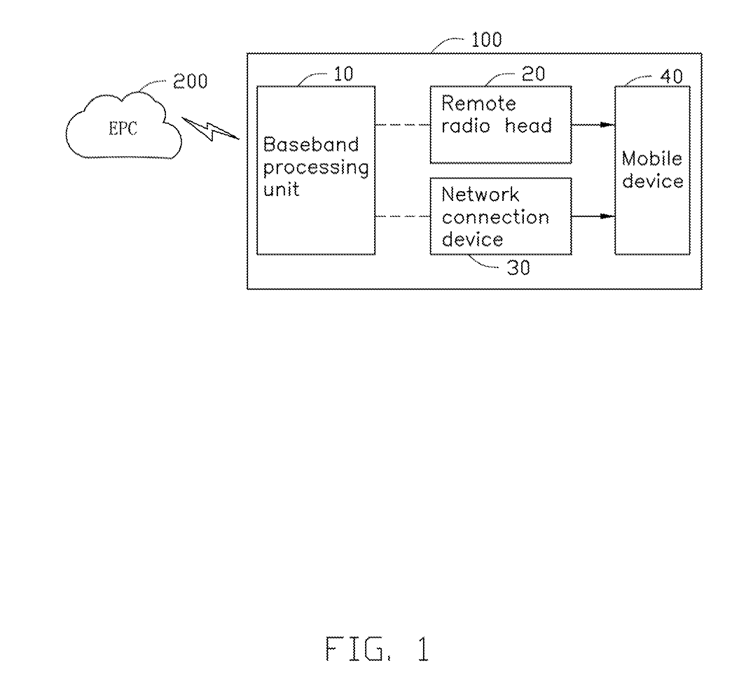

FIG. 1 illustrates an exemplary embodiment of a wireless communication system 100.

The wireless communication system 100 comprises a baseband processing unit 10, a remote radio head 20, a network connection device 30, and at least one mobile device 40.

The baseband processing unit 10 obtains downstream packets from an evolved packet core (EPC) 200.

The remote radio head 20 transmits long term evolution (LTE) data to the mobile device 40. The network connection device 30 transmits WI-FI data to the mobile device 40.

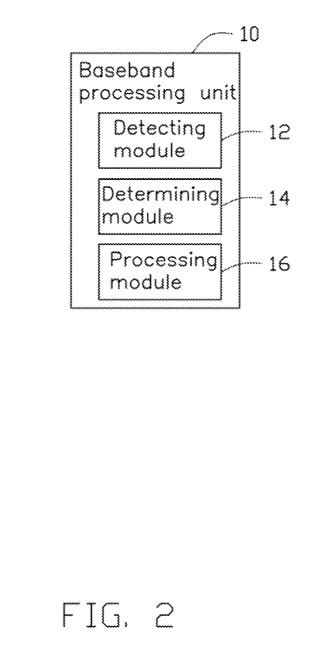

FIG. 2 illustrates that the baseband processing unit 10 comprises a detecting module 12, a determining module 14, and a processing module 16.

The detecting module 12 detects QoS Class Identifier (QCI) bearer traffic of the mobile device 40.

The determining module 14 determines whether the downstream packets is low priority data according to the QCI index.

When the determining module 14 determines that the downstream packets is not low priority data, the processing module 16 transmits LTE data to the mobile device 40 through the remote radio head 20.

When the determining module 14 determines that the downstream packets is low priority data, the processing module 16 transmits the LTE data and the Wi-Fi data to the mobile device 40 through the remote radio head 20 and the network connection device 30, respectively.

The processing module 16 obtains the data throughput of the mobile device 40 according to the LTE data and the Wi-Fi data of the mobile device 40, and adjusts the ratio between the LTE data and the Wi-Fi data transmitted to the mobile device 40 according to the data throughput of the mobile device 40.

The determining module 14 determines whether the mobile device 40 supports link aggregation between the LTE data and the Wi-Fi data. When the mobile device 40 supports link aggregation, the processing module 16 transmits LTE data to the mobile device 40 through the remote radio head 20.

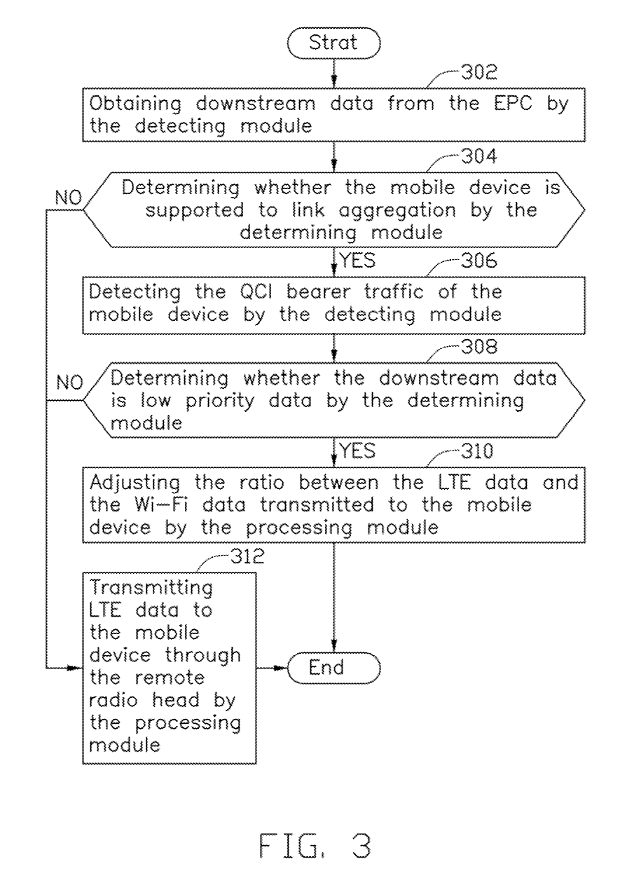

FIG. 3 illustrates a flow diagram of an exemplary embodiment of the present disclosure of a wireless communication method. A flowchart is presented as an example embodiment. The example method is provided by way of example, as there are a variety of ways to carry out the method. The method described below can be carried out using the configurations illustrated in FIG. 1, for example, and various elements of these figures are referenced in explaining example method. Blocks shown in FIG. 3 represents one or more processes, methods, or subroutines, carried out in the test method. Furthermore, the illustrated order of blocks is by example only and the order of the blocks can change. Additional blocks may be added or fewer blocks may be utilized, without departing from this disclosure. The method can begin at block 302.

At block 302, the detecting module 12 obtains downstream packets from the EPC 200.

At block 304, the determining module 14 determines whether the mobile device 40 supports link aggregation between the LTE data and the Wi-Fi data. If the mobile device 40 supports link aggregation, block 306 is implemented, otherwise the block 312 is implemented.

At block 306, the detecting module 12 detects the QCI bearer traffic of the mobile device 40.

At block 308, the determining module 14 determines whether the downstream packets is low priority data. If the downstream packets is low priority data, block 310 is implemented, otherwise the block 312 is implemented.

In the illustrated exemplary embodiment, the determining module 14 determines whether the downstream packets is low priority data according to the QCI index.

At block 310, the processing module 16 obtains the data throughput of the mobile device 40 according to the LTE data and the Wi-Fi data of the mobile device 40, and adjusts the ratio between the LTE data and the Wi-Fi data transmitted to the mobile device 40 according to the data throughput of the mobile device 40.

At block 312, the processing module 16 transmits LTE data to the mobile device 40 through the remote radio head 20.

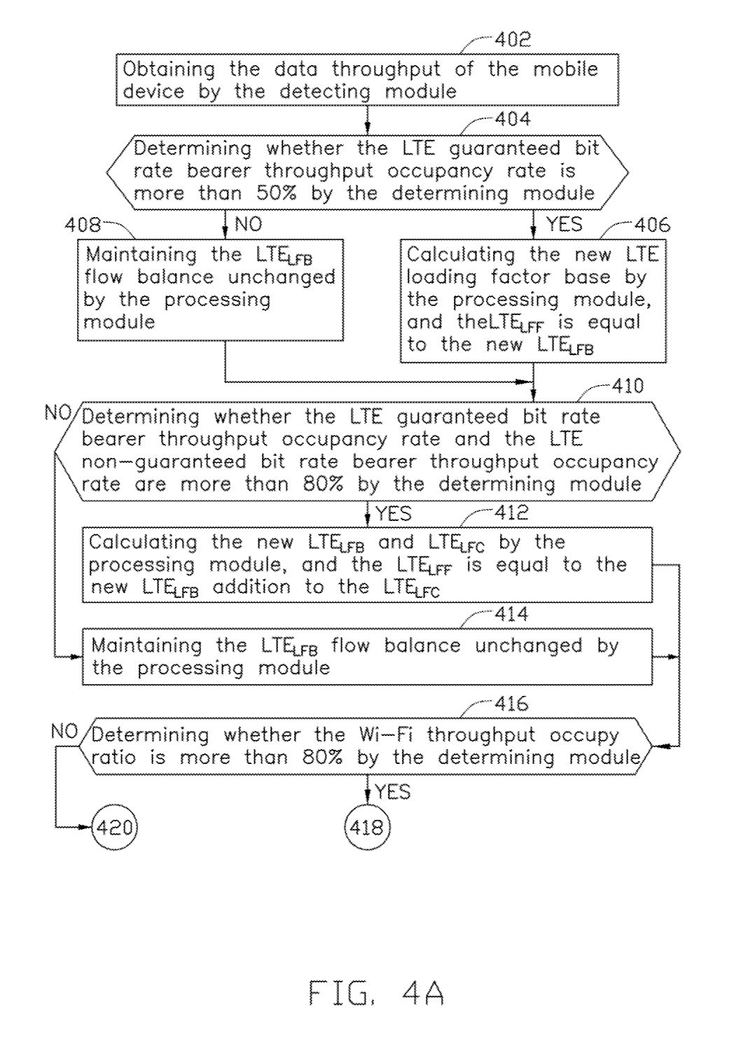

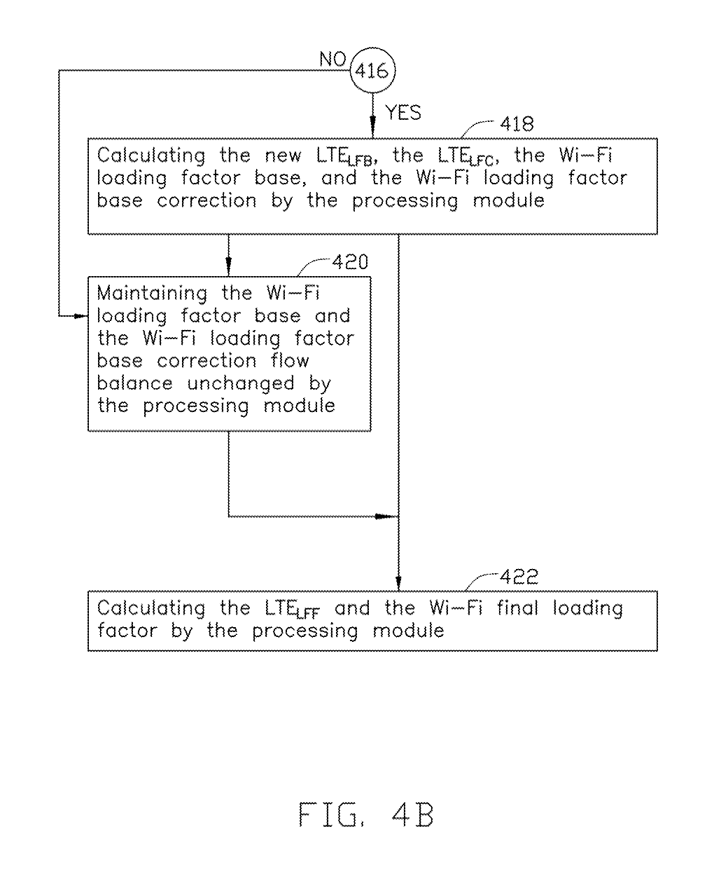

FIGS. 4A and 4B illustrates a flow diagram of an exemplary embodiment of a load ratio calculation method.

At block 402, the detecting module 12 obtains the data throughput of the mobile device 40.

At block 404, the determining module 14 determines whether the LTE guaranteed bit rate bearer throughput occupancy rate is more than 50%. If the LTE guaranteed bit rate bearer throughput occupancy ratio is more than 50%, block 406 is implemented, otherwise the block 408 is implemented.

At block 406, the processing module 16 calculates the new LTE loading factor base (LTE_{LFB}), and whether the LTE final loading factor (LTELFF) is equal to the new LTE loading factor base. The formula is as follows:

LTE_{LFF}=LTE_{LFB}

At block 408, the processing module 16 maintains the LTE loading factor base flow balance unchanged.

At block 410, the determining module 14 determines whether the LTE guaranteed bit rate bearer throughput occupancy rate and the LTE non-guaranteed bit rate bearer throughput occupancy rate are more than 80%. If the LTE guaranteed bit rate bearer throughput occupancy rate and the LTE non-guaranteed bit rate bearer throughput occupancy rate are more than 80%, block 412 is implemented, otherwise the block 414 is implemented.

At block 412, the processing module 16 calculates the new LTE loading factor base and LTE loading factor base correction (LTE_{LFC}), and whether the LTE final loading factor (LTELFF) is equal to the new LTE loading factor base addition to the LTE loading factor base correction. The formula is as follows:

LTE_{LFF}=LTE_{LFB}+LTE_{LFC}.

At block 414, the processing module 16 maintains the LTE loading factor base flow balance unchanged.

At block 416, the determining module 14 determines whether the Wi-Fi throughput occupy ratio is more than 80%. If the Wi-Fi throughput occupy ratio is more than 80%, block 418 is implemented, otherwise the block 420 is implemented.

At block 418, the processing module 16 calculates the new LTE loading factor base, the LTE loading factor base correction, the Wi-Fi loading factor base, and the Wi-Fi loading factor base correction (Wi-Fi_{LFC}). The LTE final loading factor (LTE_{LFF}) is equal to the new LTE loading factor base subtracted from the LTE loading factor base correction, and adding the maximum of Wi-Fi loading factor base correction and Wi-Fi loading factor base correction modulation and coding scheme (Wi-Fi_{LFCmcs}). The formula is as follows:

LTE_{LFF}=LTE_{LFB}−LTE_{LFC}+Max(Wi-Fi_{LFC},Wi-Fi_{LFCmcs}).

At block 420, the processing module 16 maintains the Wi-Fi loading factor base and the Wi-Fi loading factor base correction flow balance unchanged.

At block 422, the processing module 16 calculates the LTE final loading factor and the Wi-Fi final loading factor.

The embodiments shown and described above are only examples. Many details are often found in the art such as the other features of wireless communication system and method. Therefore, many such details are neither shown nor described. Even though numerous characteristics and advantages of the present disclosure have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A wireless communication method comprising:
obtaining downstream packets from an evolved packet core (EPC);
obtaining the downstream packets and transmitting long term evolution (LTE) data to at least one mobile device;
obtaining the downstream packets and transmitting wireless-fidelity (Wi-Fi) data to the mobile device; and
obtaining data throughput of the mobile device according to the LTE data and the Wi-Fi data of the mobile device and adjusting the ratio between the LTE data and the Wi-Fi data transmitted to the mobile device according to the data throughput of the mobile device.

2. The wireless communication method of claim 1, further comprising:
determining whether the mobile device supports link aggregation between the LTE data and the Wi-Fi data; and
transmitting the LTE data to the mobile device when the mobile device does not support the link aggregation.

3. The wireless communication method of claim 2, further comprising:
determining whether the downstream packets is low priority data; and
adjusting the ratio between the LTE data and the Wi-Fi data transmitted to the mobile device according to the data throughput of the mobile device when the downstream packets is low priority data.

4. The wireless communication method of claim 3, further comprising:
transmitting LTE data to the mobile device when the downstream packets is not low priority data.

5. A wireless communication system comprising:
a baseband processing unit configured for obtaining downstream packets from an evolved packet core (EPC);
a remote radio head configured for obtaining the downstream packets from the baseband processing unit and transmitting long term evolution (LTE) data to at least one mobile device; and
a network connection device configured for obtaining the downstream packets from the baseband processing unit and transmitting wireless-fidelity (Wi-Fi) data to the mobile device;
wherein the baseband processing unit obtains data throughput of the mobile device according to the LTE data and the Wi-Fi data of the mobile device and adjusts the ratio between the LTE data and the Wi-Fi data transmitted to the mobile device according to the data throughput of the mobile device.

6. The wireless communication system of claim 5, wherein the baseband processing unit further comprises a detecting module, a determining module, and a processing module; wherein
the detecting module is configured to obtain the downstream packets from the EPC;
the processing module is configured to obtain the data throughput of the mobile device according to the LTE data and the Wi-Fi data of the mobile device; and
the determining module is configured to determine whether the mobile device supports link aggregation between the LTE data and the Wi-Fi data;
wherein when the mobile device does not support to the link aggregation, the processing module transmits LTE data to the mobile device through the remote radio head.

7. The wireless communication system of claim 6, wherein the determining module is further configured to determine whether the downstream packets is low priority data, when the downstream packets is low priority data, the processing module adjusts the ratio between the LTE data and the Wi-Fi data transmitted to the mobile device according to the data throughput of the mobile device.

8. The wireless communication system of claim 7, wherein when the downstream packets is not low priority data, the processing module transmits LTE data to the mobile device through the remote radio head.

9. A wireless communication system comprising:
a detecting module, configured for obtaining downstream packets from an evolved packet core (EPC);
a remote radio head, configured for obtaining the downstream packets from the detecting module and transmitting long term evolution (LTE) data to at least one mobile device;
a network connection device, configured for obtaining the downstream packets from the detecting module and transmitting wireless-fidelity (Wi-Fi) data to the mobile device;
a processing module, configured for obtaining data throughput of the mobile device according to the LTE data and the Wi-Fi data of the mobile device and adjusts the ratio between the LTE data and the Wi-Fi data transmitted to the mobile device according to the data throughput of the mobile device; and
a determining module, configured for determining whether the mobile device supports link aggregation between the LTE data and the Wi-Fi data;
wherein when the mobile device does not support the link aggregation, the processing module transmits LTE data to the mobile device through the remote radio head.

10. The wireless communication system of claim 9, wherein the determining module is further configured to determine whether the downstream packets is low priority data, when the downstream packets is low priority data, the processing module adjusts the ratio between the LTE data and the Wi-Fi data transmitted to the mobile device according to the data throughput of the mobile device.

11. The wireless communication system of claim 10, wherein when the downstream packets is not low priority data, the processing module transmits LTE data to the mobile device through the remote radio head.
